(19) United States
(12) Patent Application Publication
(10) Pub. No.: US 2023/0266599 A1
(43) Pub. Date: Aug. 24, 2023

(54) IMAGE LIGHT GUIDE WITH COMPOUND DIFFRACTIVE OPTICAL ELEMENT AND THE HEAD-MOUNTED DISPLAY MADE THEREWITH

(71) Applicant: Vuzix Corporation, West Henrietta, NY (US)

(72) Inventor: Robert J. Schultz, Victor, NY (US)

(21) Appl. No.: 18/015,322

(22) PCT Filed: Jul. 7, 2021
(86) PCT No.: PCT/US2021/040707

§ 371 Date: Jan. 9, 2023

Related U.S. Application Data
(60) Provisional application No. 63/049,824, filed on Jul. 9, 2020.

(51) Int. Cl. G02B 27/42; G02B 27/01; G02B 27/44

(52) U.S. Cl. CPC G02B 27/4205; G02B 27/0172; G02B 27/44; G02B 27/4272

(57) ABSTRACT

An image light guide for conveying image bearing light comprising a substrate operable to propagate image-bearing light beams along a length thereof. An in-coupling diffractive optic is formed along the substrate and is operable to diffract a portion of image-bearing light beams from an image source into the substrate in an angularly encoded form. An out- coupling diffractive optic is formed along the substrate at least partially in a plane having an x-axis and a y-axis, and is operable to diffract a portion of the image-bearing light beams from the substrate in an angularly decoded form. The out-coupling diffractive optic comprises a first plurality of periodic structures and a second plurality of periodic structures operable to diffract a portion of the image-bearing light beams into diffractive orders. The first and second pluralities of periodic structures comprise a plurality of vertices, wherein each adjacent vertex along the x-axis is offset in the y-axis direction.

### CROSS-REFERENCE TO RELATED APPLICATION

This application claims the benefit of U.S. Provisional Patent Application No. 63/049,824, filed Jul. 9, 2020, which is incorporated by reference herein in its entirety.

### TECHNICAL FIELD

The present disclosure relates generally to electronic displays and more particularly to displays utilizing image light guides with diffractive optics to convey image-bearing light to a viewer.

### BACKGROUND

Head-Mounted Displays (HMD's) and virtual image near-eye displays are being developed for a range of diverse uses, including military, commercial, industrial, fire-fighting, and entertainment applications. For many of these applications, there is value in forming a virtual image that can be visually superimposed over the real-world image that lies in the field of view of the HMD user. An optical image light guide may convey image-bearing light to a viewer in a narrow space for directing the virtual image to the viewer's pupil and enabling this superposition function.

Although conventional image light guide arrangements have provided significant reduction in bulk, weight, and overall cost of near-eye display optics, further improvements are needed. In some instances, the size of the eyebox is constrained, forcing HMD designs to limit tolerances for movement and device placement. Light can often be unevenly distributed over the visual field, leading to hot spots, such as higher levels of light within the center of the field and lower light levels within the field periphery. Beam management functions within the waveguide including beam expansion and light distribution functions can increase the size of waveguides as well as their manufacturing cost and complexity.

### SUMMARY

In a first exemplary embodiment, an image light guide for conveying image bearing light includes a substrate (602, 702, 802, 902) operable to propagate image-bearing light beams along a length thereof, the substrate including a first surface and a second surface parallel to the first surface. The image light guide for conveying image bearing light also includes an in-coupling diffractive optic (604, 704, 804, 904) formed along the substrate, wherein the in-coupling diffractive optic is operable to diffract a portion of the image-bearing light beams from an image source (16) into the substrate in an angularly encoded form. Further, the image light guide for conveying image bearing light includes an out-coupling diffractive optic (500, 706, 806, 906) formed along the substrate, wherein the out-coupling diffractive optic is at least partially located in a plane having an x-axis and a y-axis, and is operable to diffract a portion of the image-bearing light beams from the substrate in an angularly decoded form. Additionally, the out-coupling diffractive optic comprises a first plurality of periodic structures (412, 424, 414) and a second plurality of periodic structures (416, 426, 418), the first and second pluralities of periodic structures operable to diffract a portion of the image-bearing light beams into diffractive orders. Further, the first and second pluralities of periodic structures comprise a plurality of vertices (352, 354, 452, 454, 2154) wherein each adjacent vertex along the x-axis is offset in the y-axis direction.

In a second exemplary embodiment, a method of fabricating an image light guide for conveying image bearing light includes providing a substrate (602, 702, 802, 902) having a flat surface, wherein a coating is coupled with the flat surface, providing a beam writing system operable to write in a first direction and a second direction, wherein the second direction is perpendicular to the first direction, and providing a diffraction grating layout pattern, comprising a plurality of unit cells (310, 410A, 410B). Each unit cell comprises a first plurality of straight line diffractive feature (412, 424, 414), and a second plurality of straight line diffractive feature (416, 426, 418), wherein one or more intersections of the first and second pluralities of straight line diffractive features define one or more corresponding vertices (352, 354, 452, 454, 2154), wherein adjacent vertices along first direction comprise an offset along a second direction. The method of fabricating an image light guide for conveying image bearing light further includes locating the substrate in said beam writing system, whereby the beam writing system is operable to write into the coating. The method also includes aligning one of the first and second pluralities of straight line diffractive features parallel with the beam writing system first direction and writing the diffraction grating layout pattern into the coating via the beam writing system.

### BRIEF DESCRIPTION OF THE DRAWINGS

The accompanying drawings are incorporated herein as part of the specification. The drawings described herein illustrate embodiments of the presently disclosed subject matter and are illustrative of selected principles and teachings of the present disclosure. However, the drawings do not illustrate all possible implementations of the presently disclosed subject matter and are not intended to limit the scope of the present disclosure in any way.

FIG. 1 shows a simplified cross-sectional view of an image light guide showing the expansion of an image-bearing beam along the direction of propagation for expanding one dimension of an eyebox.

FIG. 2 shows a perspective view of an image light guide with a turning grating showing the expansion of an image-bearing beam perpendicular to the direction of propagation for expanding a second dimension of an eyebox.

FIG. 3 shows a schematic plan view of an image light guide having an out-coupling diffractive optic with a pattern of alternating grating vectors according to an exemplary embodiment of the presently disclosed subject matter.

FIG. 4 shows a schematic of light behavior within individual diffractive patterns according to an exemplary embodiment of the presently disclosed subject matter.

FIG. 5 shows a schematic of a compound diffractive pattern according to an exemplary embodiment of the presently disclosed subject matter.

FIG. 6 shows a schematic plan view of a compound diffractive pattern according to an exemplary embodiment of the presently disclosed subject matter

FIG. 7 shows an arrangement of a diffractive pattern unit cell according to an exemplary embodiment of the presently disclosed subject matter.

FIG. 8A shows another arrangement of a diffractive pattern unit cell according to an exemplary embodiment of the presently disclosed subject matter.

FIG. 8B shows a diffractive pattern unit cell according to an exemplary embodiment of the presently disclosed subject matter.

FIG. 9A shows a schematic plan view of portion of a compound diffraction grating having three overlapping diffraction grating patterns according to an embodiment of the present disclosure.

FIG. 9B shows a vector diagram of summed grating vectors forming a closed triangle.

FIG. 10A shows a schematic plan view of an image light guide having a compound diffraction grating pattern operable to expand and out-couple image-bearing beams according to an exemplary embodiment of the presently disclosed subject matter.

FIG. 10B shows a schematic plan view of an image light guide having a compound diffraction grating pattern operable to expand and out-couple image-bearing beams according to an exemplary embodiment of the presently disclosed subject matter.

FIG. 10C shows an arrangement of a diffractive pattern unit cell according to FIG. 8A, where the unit cell is rotated about the z-axis.

FIG. 10D shows a schematic plan view of an image light guide having a compound diffraction grating pattern operable to expand and out-couple image-bearing beams according to an exemplary embodiment of the presently disclosed subject matter.

FIG. 10E shows a vector diagram of summed grating vectors forming a closed triangle.

FIG. 11 shows a schematic plan view of an image light guide having a pupil expansion diffractive optic and an exit pupil diffractive optic according to an exemplary embodiment of the presently disclosed subject matter.

FIG. 12 shows a schematic plan view of an image light guide having a pupil expansion diffractive optic and an exit pupil diffractive optic according to an exemplary embodiment of the presently disclosed subject matter.

FIG. 13 shows an input central ray that is incident to the waveguide surface at angle other than perpendicular according to an exemplary embodiment of the presently disclosed subject matter.

FIG. 14 shows a simplified cross-sectional view of an image light guide according to FIG. 13 showing a ray propagating within a waveguide.

FIG. 15 shows a simplified schematic of a portion of a compound diffractive optic according to an exemplary embodiment of the presently disclosed subject matter.

FIG. 16 shows a schematic of a portion of a compound diffraction grating pattern operable to expand and out-couple image-bearing beams according to an exemplary embodiment of the presently disclosed subject matter.

FIG. 17 shows a portion of a compound diffraction grating pattern operable to expand and out-couple image-bearing beams according to an exemplary embodiment of the presently disclosed subject matter.

FIG. 18 is a perspective view of a binocular display system for augmented reality viewing using at least one image light guide according to an exemplary embodiment of the presently disclosed subject matter.

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Where used herein, the terms “first”, “second”, and so on, do not necessarily denote any ordinal, sequential, or priority relation, but are simply used to more clearly distinguish one element or set of elements from another, unless specified otherwise.

Where used herein, the terms “viewer”, “operator”, “observer”, and “user” are considered equivalents and refer to the person or machine wearing and/or viewing images using a device having an imaging light guide.

Where used herein, the term “set” refers to a non-empty set, as the concept of a collection of elements or members of a set is widely understood in elementary mathematics. Where used herein, the term “subset”, unless otherwise explicitly stated, refers to a non-empty proper subset, that is, to a subset of the larger set, having one or more members. For a set S, a subset may comprise the complete set S. A “proper subset” of set S, however, is strictly contained in set S and excludes at least one member of set S.

Where used herein, the terms “coupled,” “coupler,” or “coupling” in the context of optics refer to a connection by which light travels from one optical medium or device to another optical medium or device.

Where used herein, the terms “vertex” and “vertices” refer to a feature of interest that repeats within a compound diffractive pattern. For example, a vertex may comprise an area where two or more lines meet, a diffractive feature comprising a post, or an area where two or more unit cells meet.

An optical system, such as a HMD, can produce a virtual image display. In contrast to methods for forming a real image, a virtual image is not formed on a display surface. That is, if a display surface were positioned at the perceived location of a virtual image, no image would be formed on that surface. Virtual image display has a number of inherent advantages for augmented reality presentation. For example, the apparent size of a virtual image is not limited by the size or location of a display surface. Additionally, the source object for a virtual image may be small; for example, a magnifying glass provides a virtual image of an object. In comparison with systems that project a real image, a more realistic viewing experience can be provided by forming a virtual image that appears to be some distance away. Providing a virtual image also obviates the need to compensate for screen artifacts, as may be necessary when projecting a real image.

An image light guide may utilize image-bearing light from a light source such as a projector to display a virtual image. For example, collimated, relatively angularly encoded, light beams from a projector are coupled into a planar waveguide by an input coupling such as an in-coupling diffractive optic, which can be mounted or formed on a surface of the planar waveguide or buried within the waveguide. Such diffractive optics can be formed as diffraction gratings, holographic optical elements (HOE's) or in other known ways. For example, the diffraction grating can be formed by surface relief. After propagating along the waveguide, the diffracted light can be directed back out of the waveguide by a similar output coupling such as an out-coupling diffractive optic, which can be arranged to provide pupil expansion along one dimension of the virtual image. In addition, a turning grating can be positioned on/in the waveguide to provide pupil expansion in an orthogonal dimension of the virtual image. The image-bearing light output from the waveguide provides an expanded eyebox for the viewer.

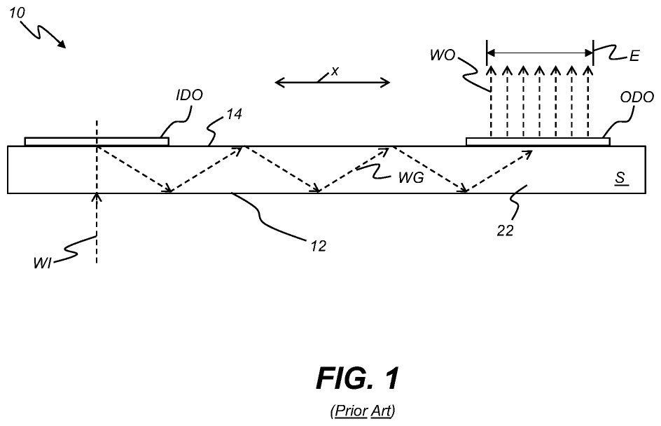

As illustrated in FIG. 1, an image light guide 10 may comprise a planar waveguide 22 having plane-parallel surfaces. The waveguide 22 comprises a transparent substrate S having an outer surface 12 and an inner surface 14 located opposite the outer surface 12. In this example, an in-coupling diffractive optic IDO and an out-coupling diffractive optic ODO are arranged on the inner surface 14 and the in-coupling diffractive optic IDO is a reflective type diffraction grating through which image-bearing light WI is coupled into the planar waveguide 22. However, the in-coupling diffractive optic IDO could alternately be a transmissive diffraction grating, volume hologram or other holographic diffraction element, or other type of optical component that provides diffraction for the incoming, image-bearing light WI. The in-coupling diffractive optic IDO can be located on the outer surface 12 or the inner surface 14 of the planar waveguide 22 and can be of a transmissive or reflective type in a combination that depends upon the direction from which the image-bearing light WI approaches the planar waveguide 22.

When used as a part of a virtual display system, the in-coupling diffractive optic IDO couples the image-bearing light WI from a real, virtual, or hybrid image source into the substrate S of the planar waveguide 22. Any real image or image dimension is first converted into an array of overlapping angularly related beams encoding the different positions within a virtual image for presentation to the in-coupling diffractive optic IDO. The image-bearing light WI is diffracted (generally through a first diffraction order) and thereby redirected by in-coupling diffractive optic IDO into the planar waveguide 22 as image-bearing light WG for further propagation along the planar waveguide 22 by Total Internal Reflection (“TIR”). Although diffracted into a generally more condensed range of angularly related beams in keeping with the boundaries set by TIR, the image-bearing light WG preserves the image information in an encoded form. The out-coupling diffractive optic ODO receives the encoded image-bearing light WG and diffracts (also generally through a first diffraction order) the image-bearing light WG out of the planar waveguide 22 as the image-bearing light WO toward the intended location of a viewer's eye. Generally, the out-coupling diffractive optic ODO is designed symmetrically with respect to the in-coupling diffractive optic IDO to restore the original angular relationships of the image-bearing light WI among outputted angularly related beams of the image-bearing light WO. However, to increase one dimension of overlap among the angularly related beams in a so-called eyebox E within which the virtual image can be seen, the out-coupling diffractive optic ODO is arranged to encounter the image-bearing light WG multiple times and to diffract only a portion of the image-bearing light WG on each encounter. The multiple encounters along the length of the out-coupling diffractive optic ODO have the effect of enlarging one dimension of each of the angularly related beams of the image-bearing light WO thereby expanding one dimension of the eyebox E within which the beams overlap. The expanded eyebox E decreases sensitivity to the position of a viewer's eye for viewing the virtual image.

In this example, the out-coupling diffractive optic ODO is a transmissive type diffraction grating arranged on the inner surface 14 of the planar waveguide 22. However, like the in-coupling diffractive optic IDO, the out-coupling diffractive optic ODO can be located on the outer surface 12 or the inner surface 14 of the planar waveguide 22 and be of a transmissive or reflective type in a combination that depends upon the direction through which the image-bearing light WG is intended to exit the planar waveguide 22.

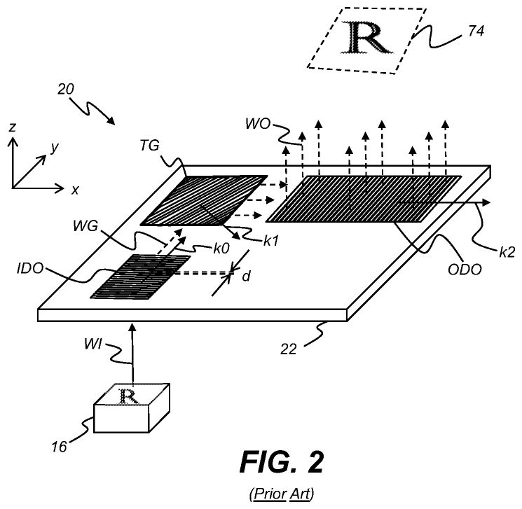

As illustrated in FIG. 2, an image light guide 20 may be arranged for expanding an eyebox 74 in two dimensions, i.e., along both x- and y-axes of the intended image. To achieve a second dimension of beam expansion, the in-coupling diffractive optic IDO is oriented to diffract the image-bearing light WG about a grating vector k0 toward an intermediate turning grating TG whose grating vector k1 is oriented to diffract the image-bearing light WG in a reflective mode toward the out-coupling diffractive optic ODO. Only a portion of the image-bearing light WG is diffracted by each of multiple encounters with intermediate turning grating TG thereby laterally expanding each of the angularly related beams of the image-bearing light WG approaching the out-coupling diffractive optic ODO. The turning grating TG redirects the image-bearing light WG into an at least approximate alignment with a grating vector k2 of the out-coupling diffractive optic ODO for longitudinally expanding the angularly related beams of the image-bearing light WG in a second dimension before exiting the planar waveguide 22 as the image-bearing light WO. Grating vectors, such as the depicted grating vectors k0, k1, k2, extend in a direction that is normal to the diffractive features (e.g., grooves, lines, or rulings) of the diffractive optics and have a magnitude inverse to the period or pitch d (i.e., the on-center distance between grooves) of the diffractive optics IDO, TG, ODO.

As illustrated in FIG. 2, the in-coupling diffractive optic IDO receives the incoming image-bearing light WI containing a set of angularly related beams corresponding to individual pixels or equivalent locations within an image generated by an image source 16. The image source 16, operable to generate a full range of angularly encoded beams for producing a virtual image, may be, but is not limited to, a real display together with focusing optics, a beam scanner for more directly setting the angles of the beams, or a combination such as a one-dimensional real display used with a scanner. The image light guide 20 outputs an expanded set of angularly related beams in two dimensions of the image by providing multiple encounters of the image-bearing light WG with both the intermediate turning grating TG and the out-coupling diffractive optic ODO in different orientations. In the original orientation of the planar waveguide 22, the intermediate grating TG provides beam expansion in the y-axis direction, and the out-coupling diffractive optic ODO provides a similar beam expansion in the x-axis direction. The reflectivity characteristics and respective periods d of the diffractive optics IDO, ODO, TG, together with the orientations of their respective grating vectors, provide for beam expansion in two dimensions while preserving the intended relationships among the angularly related beams of the image-bearing light WI that are output from the image light guide 20 as the image-bearing light WO.

While the image-bearing light WI input into the image light guide 20 is encoded into a different set of angularly related beams by the in-coupling diffractive optic IDO, the information required to reconstruct the image is preserved by accounting for the systematic effects of the in-coupling diffractive optic IDO. The turning grating TG, located in an intermediate position between the in-coupling and out-coupling diffractive optics IDO, ODO, is typically arranged so that it does not induce any significant change on the encoding of the image-bearing light WG. The out-coupling diffractive optic ODO is typically arranged in a symmetric fashion with respect to the in-coupling diffractive optic IDO, e.g., including diffractive features sharing the same period. Similarly, the period of the turning grating TG also typically matches the common period of the in-coupling and out-coupling diffractive optics IDO, ODO. As illustrated in FIG. 2, the grating vector k1 of the turning grating TG may be oriented at 45 degrees with respect to the other grating vectors k0, k2 (all as undirected line segments). However, in an embodiment, the grating vector k1 of the turning grating TG is oriented at 60 degrees to the grating vectors k0, k2 of the in-coupling and out-coupling diffractive optics IDO, ODO in such a way that the image-bearing light WG is turned 120 degrees. By orienting the grating vector k1 of the intermediate turning grating TG at 60 degrees with respect to the grating vectors k0, k2 of the in-coupling and out-coupling diffractive optics IDO, ODO, the grating vectors k0, k2 are also oriented at 60 degrees with respect to each other (again considered as undirected line segments). Basing the grating vector magnitudes on the common pitch of the turning grating TG and the in-coupling and out-coupling diffractive optics IDO, ODO, the three grating vectors k0, k1, k2 (as directed line segments) form an equilateral triangle, and sum to a zero-vector magnitude, which avoids asymmetric effects that could introduce unwanted aberrations including chromatic dispersion.

The image-bearing light WI that is diffracted into the planar waveguide 22 is effectively encoded by the in-coupling diffractive optic IDO, whether the in-coupling diffractive optic IDO uses gratings, holograms, prisms, mirrors, or some other mechanism. Any reflection, refraction, and/or diffraction of light that takes place at the in-coupling diffractive optic IDO must be correspondingly decoded by the out-coupling diffractive optic ODO to re-form the virtual image that is presented to the viewer. The turning grating TG, placed at an intermediate position between the in-coupling and out-coupling diffractive optics IDO, ODO, is typically designed and oriented so that it does not induce any change on the encoded light. The out-coupling diffractive optic ODO decodes the image-bearing light WG into its original or desired form of angularly related beams that have been expanded to fill the eyebox 74.

Whether any symmetries are maintained or not among the turning grating TG and the in-coupling and out-coupling diffractive optics IDO, ODO or whether any change to the encoding of the angularly related beams of the image-bearing light WI takes place along the planar waveguide 22, the turning grating TG and the in-coupling and out-coupling diffractive optics IDO, ODO are related so that the image-bearing light WO that is output from the planar waveguide 22 preserves or otherwise maintains the original or desired form of the image-bearing light WI for producing the intended virtual image.

The letter “R” represents the orientation of the virtual image that is visible to the viewer whose eye is in the eyebox 74. As shown, the orientation of the letter “R” in the represented virtual image matches the orientation of the letter “R” as encoded by the image-bearing light WI. A change in the rotation about the z-axis or angular orientation of incoming image-bearing light WI with respect to the x-y plane causes a corresponding symmetric change in rotation or angular orientation of outgoing light from out-coupling diffractive optic ODO. From the aspect of image orientation, the turning grating TG simply acts as a type of optical relay, providing expansion of the angularly encoded beams of the image-bearing light WG along one axis (e.g., along the y-axis) of the image. The out-coupling diffractive optic ODO further expands the angularly encoded beams of the image-bearing light WG along another axis (e.g., along the x-axis) of the image while maintaining the original orientation of the virtual image encoded by the image-bearing light WI. As illustrated in FIG. 2, the turning grating TG may be a slanted or square grating arranged on the front or back surfaces of the planar waveguide 22. Alternately, the turning grating TG may be a blazed grating.

The present disclosure provides for an improved image light guide which eliminates the need for a separate turning grating TG in the light path. More specifically, the present disclosure provides for, inter alia, a waveguide having a diffractive array operable to expand image-bearing light beams in two-dimensions and output the expanded image-bearing light beams toward an eyebox.

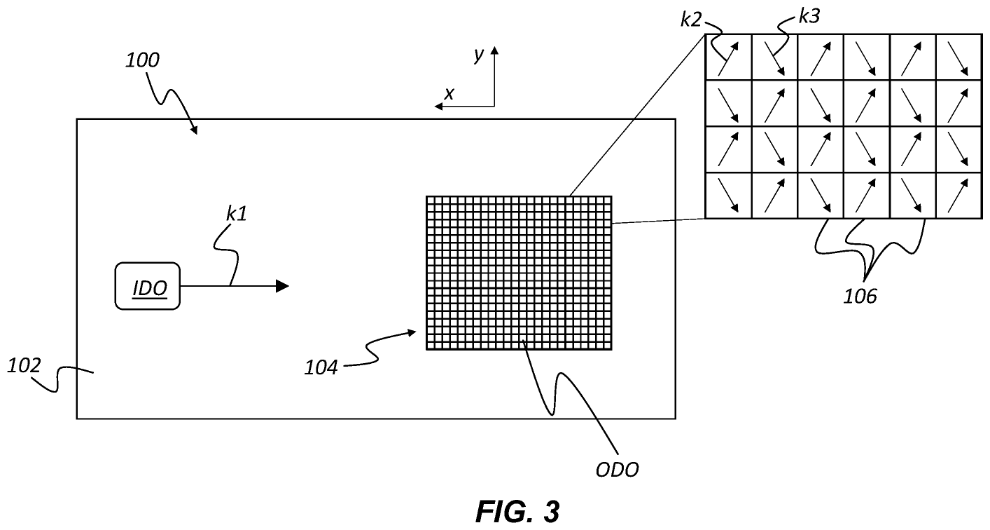

As illustrated in FIG. 3, an image light guide 100 may have an in-coupling diffractive optic IDO and an out-coupling diffractive optic ODO formed on/in a first surface 102 of the image light guide 100. Alternately, one or both of the in-coupling and out-coupling diffractive optics IDO, ODO can be formed on/in the second surface of the image light guide 100 located opposite the first surface 102. The in-coupling diffractive optic IDO has a grating vector k1 extending in the direction of the x-axis. The out-coupling diffractive optic ODO comprises a diffractive array 104. Having multiple component diffractive optical elements or optics 106. In a row of the diffractive array 104, sequential diffractive optical elements 106 have alternating grating vectors k2, k3. The alternating grating vector k2, k3 arrangement is schematically shown for a portion of diffractive array 104 in an enlarged detail view. The grating vectors k2 are offset from the in-coupling grating vector k1 and from the x-axis by +60 degrees (alternately, offset from the y-axis by −30 degrees). The grating vectors k3 are offset from the in-coupling grating vector k1 and the x-axis by −60 degrees.

The diffractive array 104 can be considered structurally formed as the union of disjointed, mutually non-overlapping subsets of diffractive elements or optics formed on a single surface. Considered in terms of set theory, this union of subsets forms a “partition”. There is a unique grating vector corresponding to each subset of the partition and the subsets are distinguished from each other according to the grating vector direction. That is, all the diffractive optical elements 106 in each subset have a common grating vector. In the spatial arrangement of diffractive optical elements 106, the diffractive optical elements 106 of at least two subsets alternate with each other, so that each diffractive optical element 106 from the subset with grating vector k2 is immediately adjacent to one or more neighboring diffractive optical elements 106 from the other subset with grating vector k3. More than two subsets of immediately adjacent diffractive optical elements 106 can be used to constitute the partition of the diffractive array 104; each subset having a grating vector that extends in a different direction from the corresponding grating vector for any other subset.

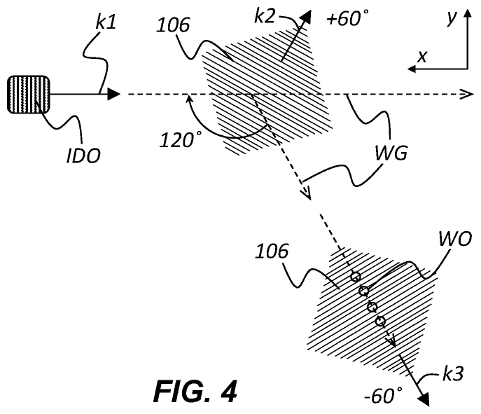

Referring now to FIG. 4, when the light WG incident from the in-coupling diffractive optic IDO interacts with the diffractive array 104 a portion of the incident light WG is diffracted and directed, at an angle to the original path of light, to other portions of the diffractive array 104. As illustrated in FIG. 4, in an embodiment, when the incident light WG interacts with a diffractive optical element 106 having a grating vector k2, some portion of the incident light WG is diffracted and thereby deflected 120° from the original path of light from the in-coupling diffractive optic IDO. Similarly, when the incident light WG interacts with a diffractive optical element 106 having a grating vector k3, some portion of the incident light WG is diffracted and thereby deflected −120° from the original path of light from the in-coupling diffractive optic IDO. Another portion of the incident light WG travels through the diffractive optical element 106 to the immediately adjacent diffractive optical element 106 having a different grating vector. When the diffracted and deflected light WG is incident upon a diffractive optical element 106 at an angle substantially parallel to the grating vector k2, k3 thereof, a portion of the light WO is out-coupled from the image light guide 100.

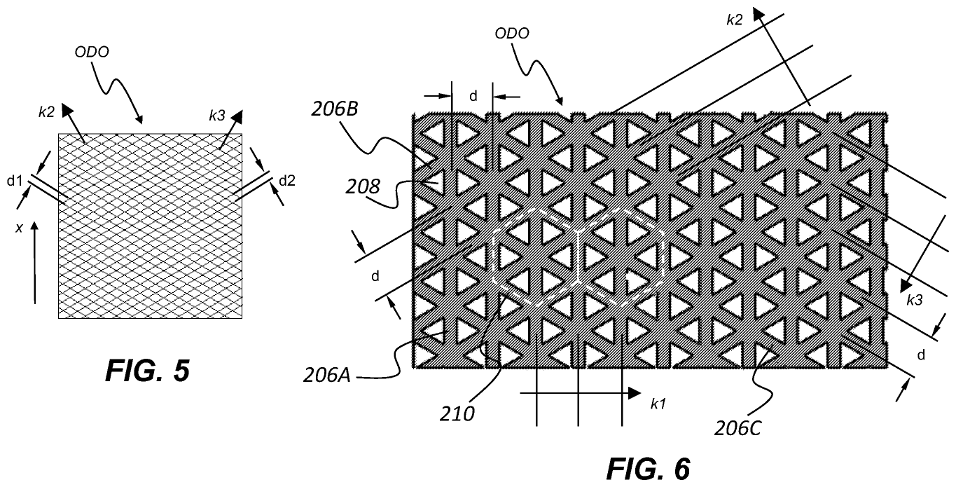

As illustrated in FIG. 5, in an embodiment, an out-coupling diffractive optic ODO comprises a first diffraction grating having a grating vector k2 and a second diffraction grating having a grating vector k3. The first and second diffraction gratings are overlapped to create an angular relation of the grating vectors k2, k3 between 0° and 180°. In an embodiment, the angular relation between the grating vectors k2, k3 is approximately 60°. When light diffracted and directed by the first diffraction grating is incident upon the second diffraction grating at an angle substantially orthogonal to the features thereof (e.g., lines), a portion of the light is out-coupled from the image light guide.

With continued reference to FIG. 5, in an embodiment, the period d1 of the first diffraction grating is equal to the period d2 of the second diffraction grating. In another embodiment, the period d1 is greater than the period d2. In another embodiment, the period d1 is smaller than the period d2. In yet another embodiment, at least one of the first and second diffraction patterns includes a chirped period d1, d2 that changes in the direction of the grating vector k2, k3.

As illustrated in FIG. 6, in an embodiment, an out-coupling diffractive optic ODO comprises a compound diffractive pattern including a first diffraction grating 206A having a grating vector k1, a second diffraction grating 206B, having a grating vector k2, and a third diffraction grating 206C having a grating vector k3. The first, second, and third diffraction gratings 206A, 206B, 206C overlap in the same plane (i.e., on/in the same surface of the image light guide). In an embodiment, the period d of each diffraction grating 206A, 206B, 206C may be the same. In another embodiment, the period d of one or more diffraction gratings 206A, 206B, 206C may be different. In an embodiment, the period d of one or more diffraction gratings 206A, 206B, 206C is chirped. As shown, all three grating vectors k1, k2, k3 are related by angles of 60° (when considered as undirected line segments). Basing the grating vector magnitudes on a common pitch, the three grating vectors k1, k2, k3 (as directed line segments) may be organized in a vector diagram forming an equilateral triangle and summing to zero magnitude. In other arrangements, the grating vectors k1, k2, k3 can be relatively oriented by different angular amounts.

With continued reference to FIG. 6, when the compound diffractive pattern is produced through subtractive manufacturing techniques, the remaining material forms diffractive features 208. As illustrated in FIG. 6, in an embodiment, the diffractive features 208 are triangular. However, in other embodiments, the diffractive features 208 may be shapes such as, but not limited to, hexagonal, as determined by the distribution of removed material.

In an embodiment, the diffraction gratings 206A, 206B, 206C are formed by the arrangement of replicating unit cells 210 located in a two-dimensional lattice. As illustrated in FIG. 6, the entire compound diffractive pattern of the out-coupling diffractive optic ODO is formed by the replication and contiguous arrangement of the hexagonal unit cell 210. Adjacent unit cells 210 share vertices within the two-dimensional lattice. Although the grating vectors k1, k2, k3 are relatively oriented with respect to each other through 60°, the unit cell 210 enables the shaping and orienting of the diffractive features 208 within the compound diffractive pattern. For example, the relative orientations and periods of the grating vectors k1, k2, k3 would remain unchanged even if the diffractive features 208 were shaped as squares, rectangles, circles or ovals. The diffractive features 208 may be defined by material remaining following a machining or other subtractive manufacturing process, or by material removed by a machining or other subtractive manufacturing process. The diffractive features 208 may be defined by an optical property that differentiates the diffractive features 208 from their surroundings, such as a difference in refractive index.

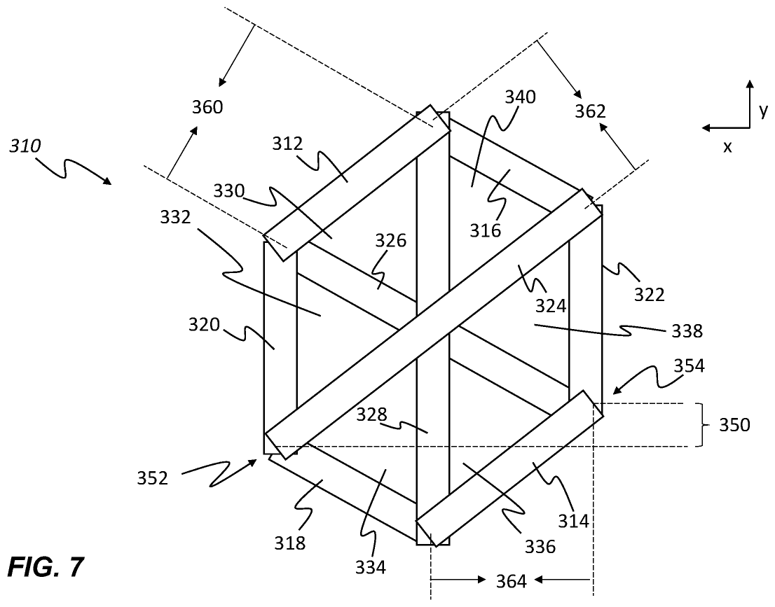

As illustrated in FIG. 7, in an embodiment, a unit cell 310 defines a non-regular hexagon operable to form a compound diffractive pattern. The unit cell 310 includes a first pair of diffractive features 312, 314 having generally the same length, a second pair of diffractive features 316, 318 having generally the same length, and a third pair of diffractive features 320, 322 having generally the same length. The first, second, and third pairs of diffractive features are not the same length. For example, the diffractive features 312, 320, 316 have different lengths. The first, second, and third pairs of diffractive features 312, 320, 318, 314, 322, 316 define the non-regular hexagon of the unit cell 310.

The unit cell 310 also includes a fourth diffractive feature 324, a fifth diffractive feature 326, and a sixth diffractive feature 328. The fourth, fifth, and sixth diffractive features 324, 326, 328 are crossed within the non-regular hexagon of the unit cell 310. The first, second, and third pairs of diffractive features 312, 320, 318, 314, 322, 316 and the fourth, fifth, and sixth diffractive features 324, 326, 328 define six area domains 330, 332, 334, 336, 338, 340.

The width of the diffractive features 312, 324, 314 is approximately the same and may be greater than 50 nm. In an embodiment, the width of the diffractive features 312, 324, 314 is in a range between 200 nm and 600 nm. The width of the diffractive features 316, 326, 318 is approximately the same and may be greater than 50 nm. In an embodiment, the width of the diffractive features 316, 326, 318 may be in a range between 200 nm and 600 nm. The width of the diffractive features 320, 328, 322 is approximately the same and may be greater than 50 nm. In an embodiment, the width of the diffractive features 320, 328, 322 is in a range between 200 nm and 600 nm. The width of the diffractive features 312, 324, 314, the width of the diffractive features 316, 326, 318, and the width of the diffractive features 320, 328, 322 may not all be the same. Additionally, in an embodiment, the depth of the diffractive features 312, 324, 314, 320, 328, 322, 316, 326, 318 is the same or equivalent. In another embodiment, the depth of the diffractive features 312, 324, 314, 320, 328, 322, 316, 326, 318 is not the same or equivalent.

In an embodiment, the index of refraction of the six area domains 330, 332, 334, 336, 338, 340 is the same or approximately the same. For example, the index of refraction of the six area domains 330, 332, 334, 336, 338, 340 may be equivalent, or approximately equivalent, to the index of refraction of air. The index of refraction of the six area domains 330, 332, 334, 336, 338, 340 is not the same as the index of refraction of the diffractive features 312, 324, 314, 320, 328, 322, 316, 326, 318. The index of refraction of the diffractive features 312, 324, 314, 320, 328, 322, 316, 326, 318 may be the same or approximately the same to one another. The index of refraction of the diffractive features 312, 324, 314, 320, 328, 322, 316, 326, 318 may be approximately that of the index of refraction of air. In an embodiment, the index of refraction of the diffractive features 312, 324, 314, 320, 328, 322, 316, 326, 318 is in the range of 1.25 to 3.5.

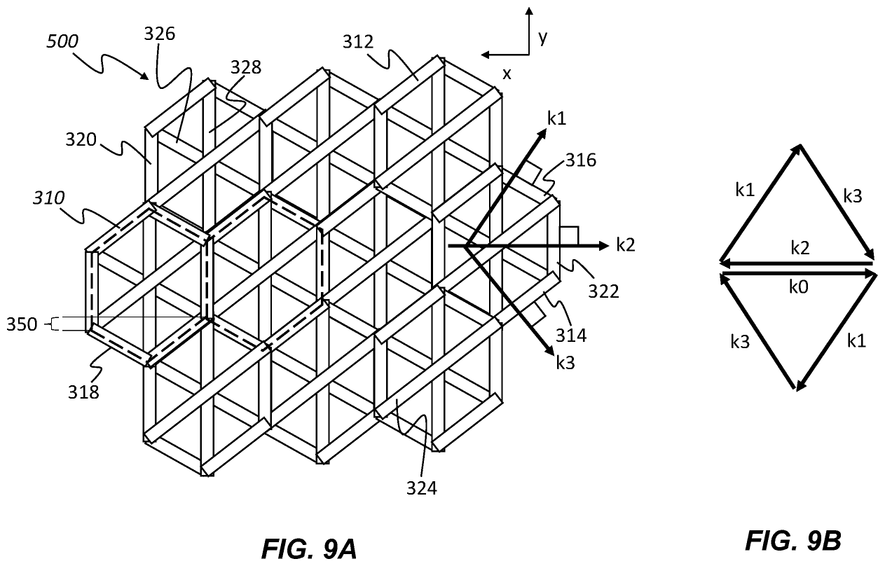

With continued reference to FIG. 7, in an embodiment, the unit cell 310 includes a vertical offset 350 between a vertex 352 and vertex 354 in the y-axis direction (i.e., the vertical direction as shown in FIG. 7). In an embodiment, the vertical offset 350 has a distance between 10 nm and 100 nm. In an embodiment, the vertical offset 350 is approximately 65 nm. The vertex 352 is defined, at least in part, by the intersection of the diffractive features 318, 320, 324. The vertex 354 is defined, at least in part, by the intersection of the diffractive features 314, 322, 326. As illustrated in FIG. 9A, the vertical offset 350 is the step change from one unit cell 310 to a neighboring unit cell 310. In an embodiment, the vertical offset 350 defines the geometry of the six area domains 330, 332, 334, 336, 338, 340 as scalene triangles rather than equilateral triangles. The shape of the six area domains 330, 332, 334, 336, 338, 340 as scalene triangles enables diffraction of off axis inputs symmetrically disposed through the center of the compound diffractive pattern.

The vertical offset 350 is generally consistent within the compound diffractive pattern. As described in further detail below, in an embodiment, the consistency of the vertical offset 350 facilitates manufacturing the compound diffractive pattern via a digital write process.

Referring still to FIG. 7, in an embodiment, the diffractive features 316, 326 have a pitch 360, the diffractive features 312, 324 have a pitch 362, and the diffractive features 322, 328 have a pitch 364. In an embodiment, the diffractive feature pitches 360, 362, 364 are different from one another. The diffractive feature pitches 360, 362, 364 may be in the range of 300 nm to 500 nm. In an embodiment, the pitch 360 is approximately 356 nm and the pitch 362 is in the range of 300 nm to 500 nm. In an embodiment, pitch 362 is approximately 323 nm. In an embodiment, the pitch 364 is in the range of 300 nm to 500 nm. In another embodiment, the pitch 364 is approximately 305 nm.

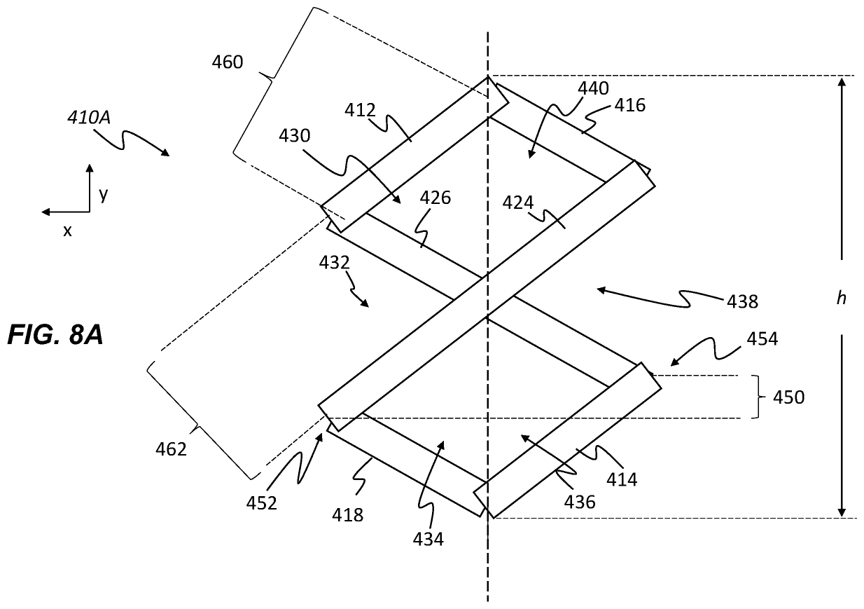

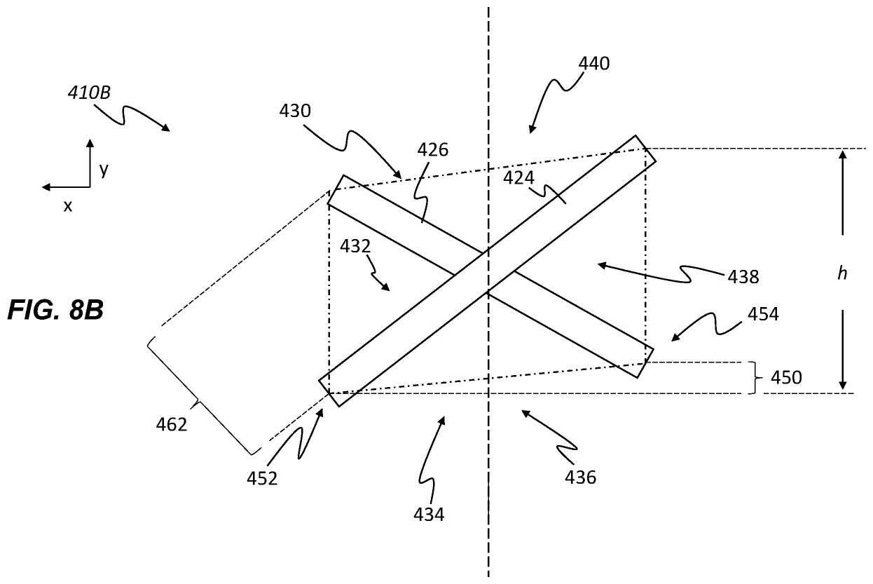

As illustrated in FIG. 8A, in an embodiment, a unit cell 410A defines an offset diffraction pattern operable to form a compound diffractive pattern. In the unit cell 410A, the diffractive features of the unit cell 310 which are parallel to the diffractive features of the associated in-coupling diffractive optic IDO (for example, the diffractive features 320, 328, 322 shown in FIG. 7) are not fabricated. The unit cell 410A includes a first pair of diffractive features 412, 414 having generally the same length and a second pair of diffractive features 416, 418 having generally the same length. The first and second pairs of diffractive features are not the same length. The different lengths of the first and second pairs of diffractive features 412, 414, 416, 418 at least partially define the offset 450 of the unit cell 310. In an embodiment, the vertical offset 450 is between a vertex 452 and a vertex 454 in the y-axis direction. The vertex 452 is defined by an, at least partial, intersection of the diffractive feature 424 and the diffractive feature 418. The vertex 454 is defined by an, at least partial, intersection of the diffractive feature 426 and the diffractive feature 414.

The unit cell 410A also includes a diffractive feature 424 and a diffractive feature 426 crossed relative to one another. The first and second pairs of diffractive features 412, 414, 416, 418 and the diffractive features 424, 426 define six area domains 430, 432, 434, 436, 438, 440. In an embodiment, the diffractive features 416, 426 have a pitch 460 and the diffractive features 412, 424 have a pitch 462.

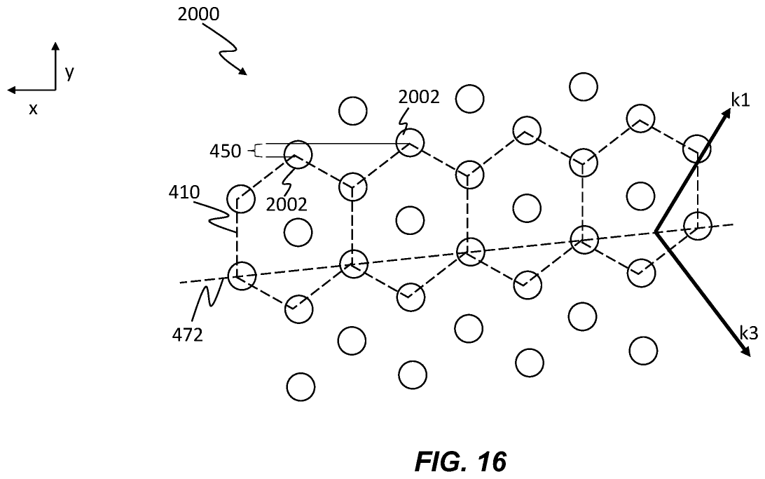

The diffractive features may also be referred to herein as periodic structures. In embodiments, the periodic structures may be, but are not limited to, straight line diffractive features, circular posts, or elliptical posts. For example, FIG. 16 shows a compound diffractive pattern 2000 having periodic structures comprising circular posts 2002. The periodic structures 2002 comprise an arrangement of unit cells 410 in a periodic grid, forming a two-dimensional periodic lattice structure. The unit cells 410 describe an offset 450 wherein each adjacent periodic structure 2002 along line 472 is offset in the y-axis direction.

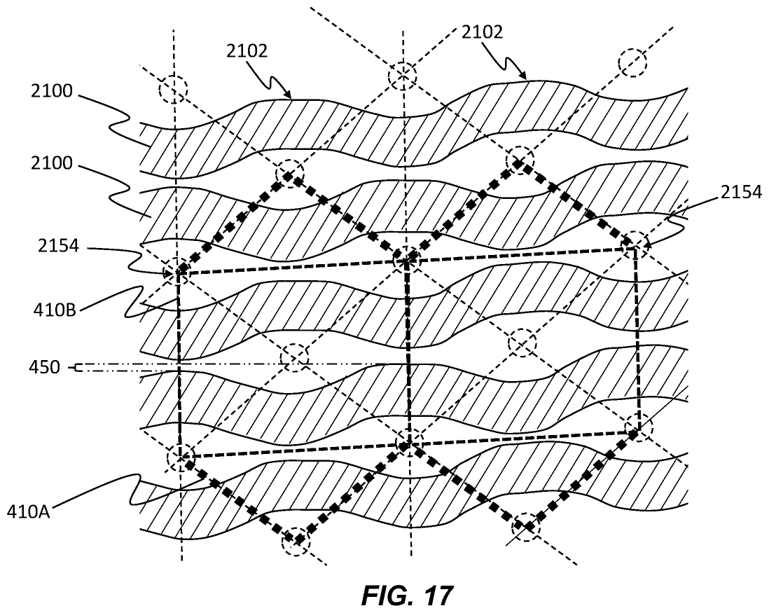

In an embodiment, as illustrated in FIG. 17, the regular variation defining the periodicity of the compound diffraction pattern is a pattern of sinusoidal structures 2100. The compound diffraction pattern can have more than three vector components. Therefore, the generated diffraction orders of the compound diffraction pattern are optimized to facilitate the desired performance. The periodicity of the compound diffractive pattern in the y-axis direction is created by the regular or average spacing between the rows of contiguous grating features 2100 in the y-axis direction. In an embodiment, a row 2100 of the sinusoidal pattern may be out of phase with the row adjacent thereto in the y-axis direction. The periodic structures 2100 comprise an arrangement of unit cells 410A and/or unit cells 410B in a periodic grid, forming a two-dimensional periodic lattice structure. The unit cells 410B define a parallelogram and the unit cells 410A define an irregular hexagon. The unit cells 410A, 410B describe an offset 450 wherein each adjacent peak 2102 of the periodic structure 2100 along the x-axis direction is offset in the y-axis direction. In other words, the unit cells 410A define a vertex 2154 at an intersection of two or more unit cells 410A and each adjacent vertex along the x-axis direction comprises the offset 450 in the y-axis direction.

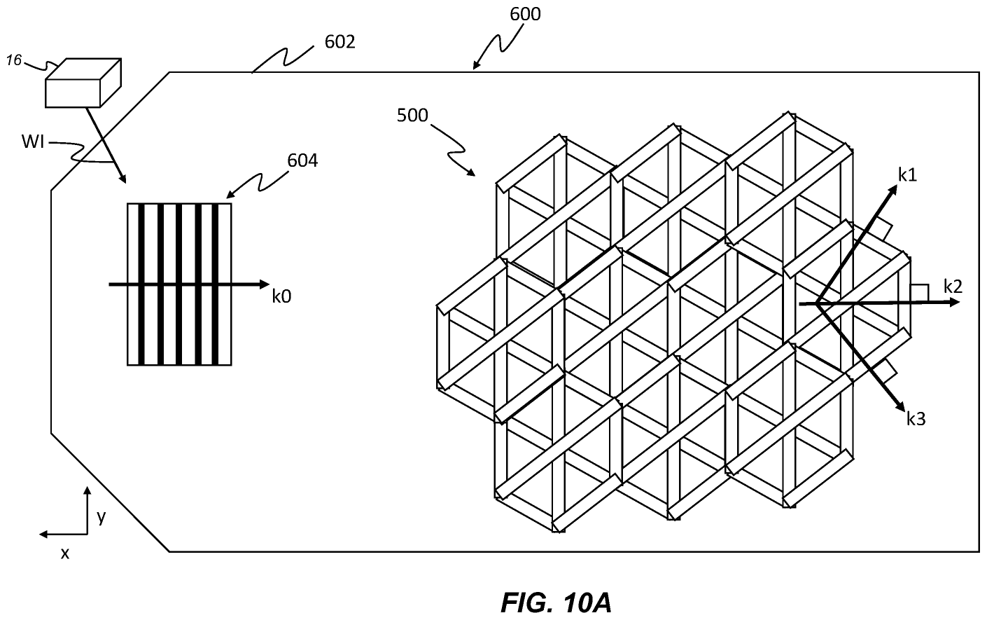

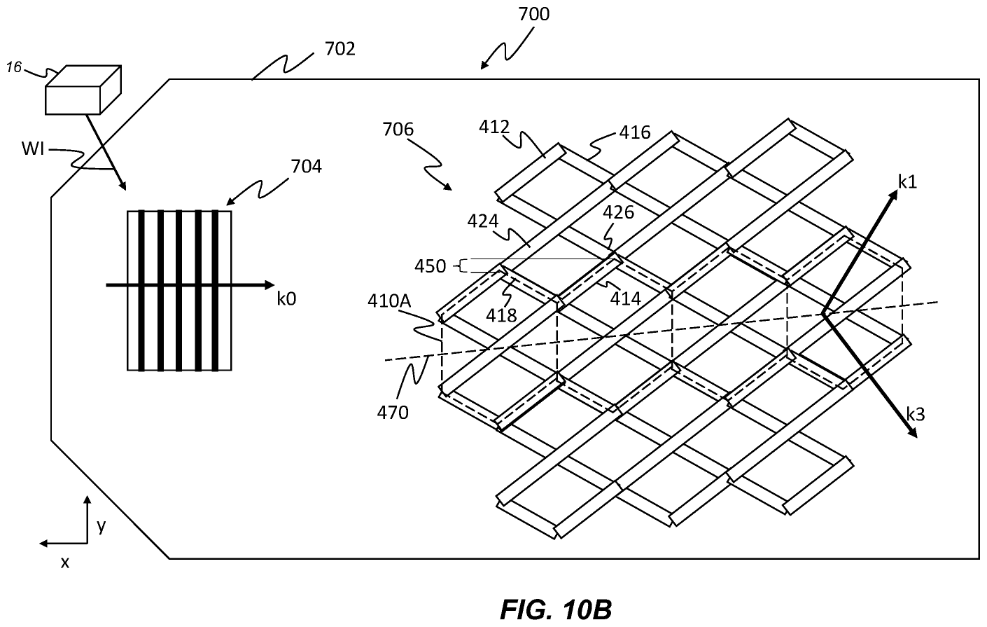

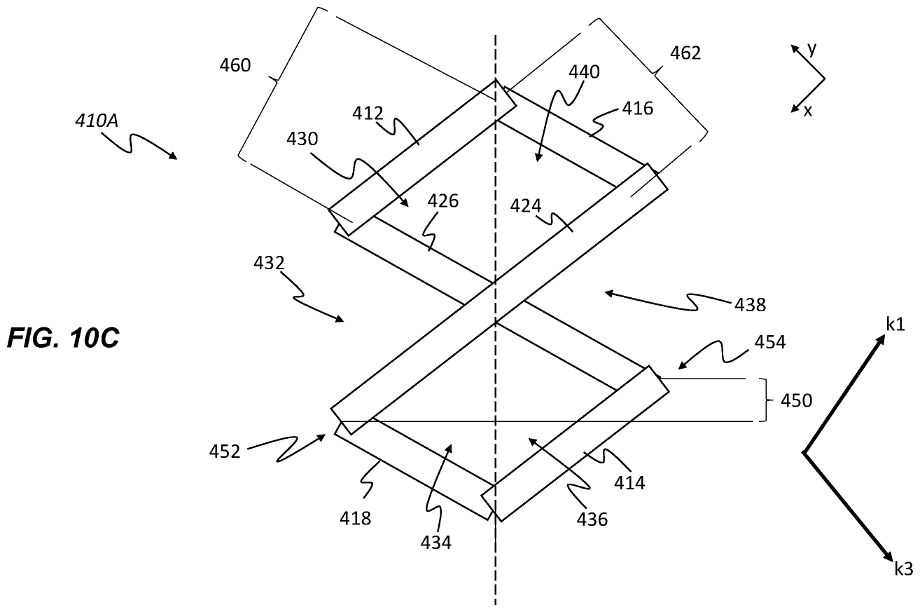

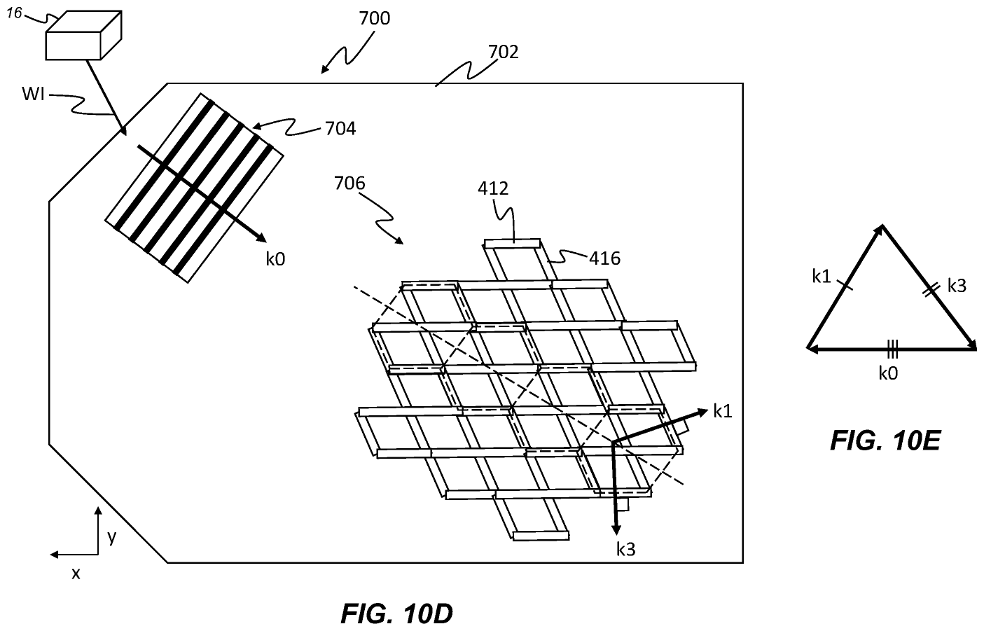

As illustrated in FIG. 10B, the vertical offset 450 is the step change from one unit cell 410A to a neighboring unit cell 410A. The unit cells 410A create a lattice and/or regular tiling (i.e., tessellation) in which three unit cells 410A meet at each internal vertex (i.e., each vertex comprising more than two straight line diffractive features). The unit cells 410A form a lattice with diagonal rows each having a centerline 470 arranged at a non-zero degree angle with the grating vector k0 of the in-coupling diffractive optic 704.

In an embodiment, as illustrated in FIG. 10C, the width and index of refraction of the first and second pairs of diffractive features 412, 414, 416, 418 and the diffractive features 424, 426 are similar to those described with reference to unit cell 310. Even though a diffractive feature does not separate area domains 430, 440 and 434, 436, respectively, six distinct area domains are implicitly defined by the unit cell 410A. Designing the unit cell 410A, and a compound diffractive pattern formed therewith, without diffractive features parallel to the diffractive features of the associated in-coupling diffractive optic IDO is utilized to prevent undesired diffraction for a specific diffraction order (i.e., order of diffraction) of the image-bearing light WG.

In an embodiment, as illustrated in FIG. 8B, the unit cell 410B may be defined as a parallelogram. In this embodiment, the unit cell 410B comprises the diffractive features 424, 426. The vertex 452 is defined, at least in part, by an end of the diffractive feature 424. The vertex 454 is defined, at least in part, by an end of the diffractive feature 426.

FIG. 9A shows a schematic plan view of portion of a compound diffraction grating 500 according to the present disclosure. The compound diffraction grating 500 comprises repeating unit cells 310, as shown in FIG. 7, forming three overlapping diffraction gratings. Grating vector k1 extends in a direction that is normal to the diffractive features 316, 326, 318, grating vector k2 extends in a direction that is normal to the diffractive features 320, 328, 322, and grating vector k3 extends in a direction that is normal to the diffractive features 312, 324, 314.

As shown in FIG. 9B, in an embodiment, a combination of grating vector k1, grating vector k3, and an in-coupling diffractive optic grating vector k0 (see FIG. 10A) form a vector diagram defining a closed triangle and having substantially zero magnitude. In other words, a combination of grating vectors k0, k1, k3 forms a vector having substantially no magnitude. Similarly, a combination of grating vectors k1, k2, k3 form a vector diagram defining a closed triangle and having substantially zero magnitude. Thus, all grating vectors in the waveguide (e.g., parallel plate waveguide system 600, 700) sum to substantially zero magnitude. In an embodiment, the grating vectors k0, k1, k3 form a closed scalene triangle.

In another embodiment, grating vectors k0, k1, k3 form a closed equilateral triangle. In another embodiment, grating vectors k0, k1, k3 form a closed isosceles triangle.

It is to be understood that due to manufacturing variability, the dimensions specified may vary depending on the manufacturing method. The figures may show sharp edges and sharp vertices when in fact, as is known to those skilled in the art, the manufactured results will have rounded edges and round vertices. The degree of sharpness or rounding of the sharp features described in this disclosure will depend, at least in part, on the manufacturing process. Similarly, where the figures show sharp edges and sharp vertices, the features may be designed to have rounded edges and/or round vertices.

FIG. 10A shows a schematic of a parallel plate waveguide system 600 comprising a waveguide 602 (i.e., substrate) having an input diffractive optic 604 and the pupil expansion compound diffraction grating 500. Input diffractive optic 604 has grating vector k0. Pupil expansion compound diffraction grating 500 acts as an exit diffraction grating in addition to performing the pupil expansion. As described in relation to FIG. 9B, in an embodiment grating vectors k0, k1, and k3 form a closed triangle. Similarly, grating vectors k0, k1, k2 and grating vectors k0, k3, k2 form vector diagrams of closed triangles.

FIG. 10B shows a schematic of a parallel plate waveguide system 700 comprising a waveguide 702 (i.e., substrate) having an input diffractive optic 704 and a pupil expansion compound diffraction grating 706. Input diffractive optic 704 has grating vector k0. The pupil expansion compound diffraction grating 706 comprises repeating unit cells 410 as shown in FIGS. 8A and 8B. The pupil expansion compound diffraction grating 706 acts as both an exit diffraction grating and a pupil expander. Grating vector k1 extends in a direction that is normal to the diffractive features 416, 426, 418 and grating vector k3 extends in a direction that is normal to the diffractive features 412, 424, 414. In an embodiment grating vectors k0, k1, and k3 combine to form a vector diagram defining a closed triangle having substantially zero magnitude.

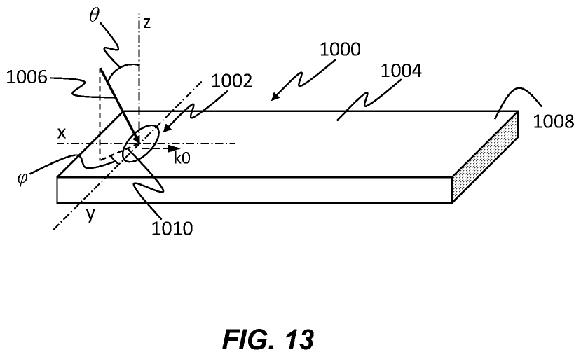

As illustrated in FIGS. 10C and 10D, in an embodiment, the compound diffraction grating 706 may be rotated within the xy-plane of the waveguide 702 so that a first plurality of the periodic structures are oriented parallel with the x-axis and an edge of the waveguide 702. The vector diagram formed by the grating vectors k0, k1, and k3 defines a scalene triangle. Where, as illustrated in FIG. 10D, the input center ray WI is disposed at a complex angle relative to the grating vector k0 of the in-coupling diffractive optic 704, the vector diagram formed by the grating vectors k0, k1, k2/k3 defines a scalene triangle. In FIG. 10D the in-coupling diffractive optic grating vector k0 is tilted down in the xy-plane; if the in-coupling diffractive optic grating vector k0 is rocked to the left in the xy-plane, the resultant central image path WI will not align with the in-coupling diffractive optic grating vector k0, necessitating non-regular hexagonal (or parallelogram) unit cells 410. If the optical system is rotated or the input center ray WI is at a complex angle relative to the input grating vector k0, then a scalene triangle relationship should exist between the grating vectors k0, k1, k2/k3. In an embodiment, in-coupling diffractive optic grating vector k0 is aligned parallel with the out-coupling diffractive optic grating vector k1. In another embodiment, in-coupling diffractive optic grating vector k0 is aligned parallel with the out-coupling diffractive optic grating vector k3. In yet another embodiment, in-coupling diffractive optic grating vector k0 is aligned parallel with a line bisecting the out-coupling diffractive optic grating vectors k1, k3. As illustrated in FIG. 13, where the input center ray 1006 is disposed at a complex angle relative to the grating vector k0 of the in-coupling diffractive optic 1002, the grating vectors k0, k1, k3 of the in-coupling and out-coupling diffractive optics needs to be considered independently to form a closed scalene triangle vector diagram.

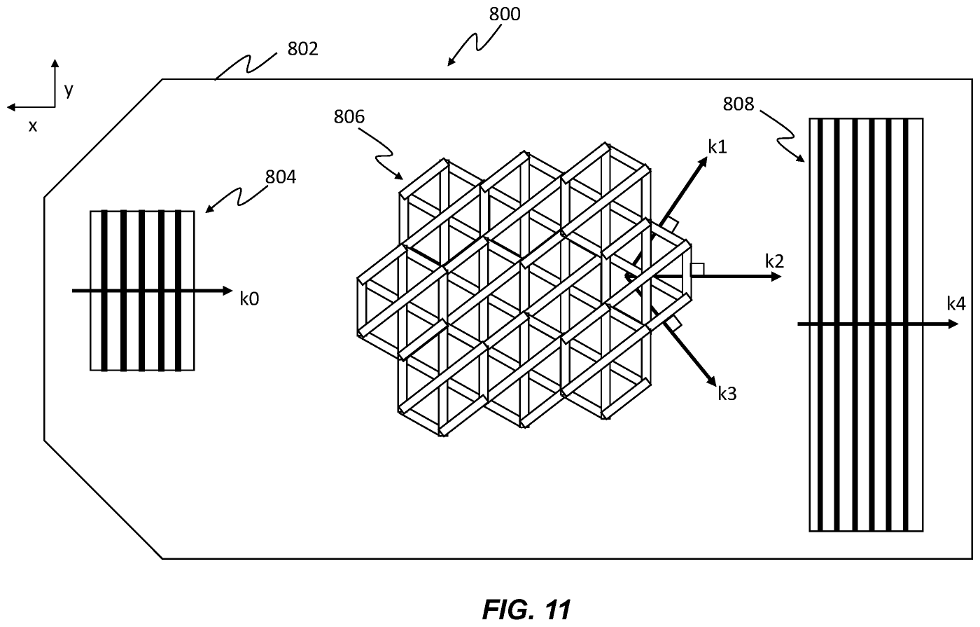

As illustrated in FIG. 11, in an embodiment, a parallel plate waveguide system 800 includes a waveguide 802. The waveguide 802 includes an in-coupling diffractive optic 804, a pupil expansion compound diffractive optical element 806, and an out-coupling diffractive optic 808. Input diffractive optic 804 has grating vector k0 and the pupil expansion compound diffractive optical element 806 comprises grating vectors k1, k2, k3. In an embodiment, the pupil expansion compound diffractive optical element 806 is defined by the unit cell 310. The out-coupling diffractive optic 808 has a grating vector k4. In an embodiment, the grating vector k0 is equal in magnitude and direction to the grating vector k4. In an embodiment, grating vectors k0, k1, k3 form a vector diagram describing a closed triangle as described with reference to FIG. 9B. Referring still to FIG. 11, in an embodiment, grating vectors k4, k1, k3 form a vector diagram of a closed triangle. In one embodiment, grating vectors k4, k1, k3 form an equilateral triangle. In another embodiment, grating vectors k4, k1, k3 form a scalene triangle. In still another embodiment, grating vectors k4, k1, k3 form an isosceles triangle.

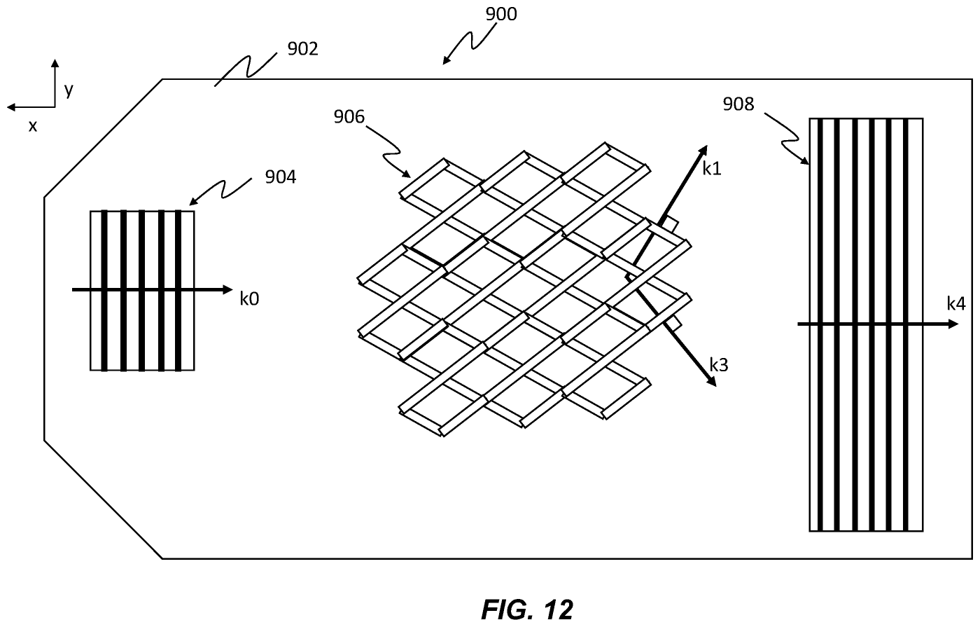

As illustrated in FIG. 12, in an embodiment, a parallel plate waveguide system 900 includes a waveguide 902. The waveguide 902 includes an in-coupling diffractive optic 904, a pupil expansion compound diffractive optical element 906, and an out-coupling diffractive optic 908. Input diffractive optic 904 has grating vector k0 and the pupil expansion compound diffractive optical element 906 comprises grating vectors k1, k3. In an embodiment, the pupil expansion compound diffractive optical element 906 is defined by the unit cell 410. The out-coupling diffractive optic 908 has a grating vector k4. In an embodiment, the grating vector k0 is equal in magnitude and direction to the grating vector k4. In an embodiment, grating vectors k0, k1, k3 form a vector diagram describing a closed triangle as described with reference to FIG. 9B. Referring still to FIG. 12, in an embodiment, grating vectors k4, k1, k3 form vector diagram of a closed triangle. In one embodiment, grating vectors k4, k1, k3 form an equilateral triangle. In another embodiment, grating vectors k4, k1, k3 form a scalene triangle. In still another embodiment, grating vectors k4, k1, k3 form an isosceles triangle.

Referring now to FIG. 13, a waveguide assembly 1000 includes an in-coupling diffractive optic 1002 operable to couple image-bearing light beams into the waveguide 1004. The center ray 1006 of the image-bearing light beam describing the input image may impinge onto the in-coupling diffractive optic 1002 at an angle other than perpendicular to a first surface 1008 of the waveguide 1004. As illustrated in FIG. 13, in an embodiment, the center ray 1006 makes an angle 9 with respect to the z-axis. The z-axis is perpendicular to the waveguide first surface 1008. As illustrated by the line segment 1010 projected in the xy-plane, the center ray 1006 incident on the in-coupling diffractive optic 1002 makes an angle co from the y-axis.

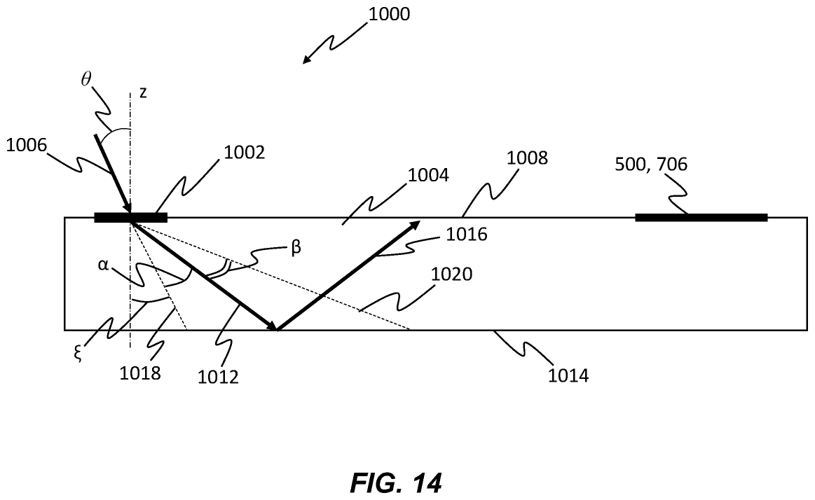

FIG. 14 is a side view of the waveguide assembly 1000 shown in FIG. 13. The center ray 1006 is shown incident onto the in-coupling diffractive optic 1002. A resulting diffracted ray 1012 propagates through the waveguide 1004 to a second surface 1014 of the waveguide 1004 where the diffracted ray 1012 undergoes total internal reflection (TIR) to become ray 1016. The ray 1016 continues to propagate through the waveguide 1004 via TIR. The in-coupling diffractive optic 1002 grating vector k0 (see FIG. 13) is designed such that the center ray 1006 is diffracted resulting in a diffracted ray 1012 that is angled approximately halfway between the TIR minimum boundary line 1018 and the TIR maximum boundary line 1020. The TIR minimum boundary line 1018 is the line defined by angle measured from the z-axis. Angle is the minimum angle at which TIR begins. That is, any ray with an angle larger than angle with respect to the z-axis will undergo TIR when it is incident onto the waveguide second surface 1014 and first surface 1008. In an embodiment, angle a is approximately the same as angle R. TIR maximum boundary line 1020 is the ray path with the maximum angle from the z-axis at which a ray will undergo TIR. In other words, only a diffracted ray at an angle between the TIR minimum and maximum boundary lines 1018, 1020 will result in the ray being incident upon the compound diffractive optic 500, 706 at least once, possibly through multiple TIR reflections from first and second surfaces 1008, 1014. The z-axis, the TIR minimum boundary line 1018, the TIR maximum boundary line 1020, and the diffracted ray 1012 are all shown in the same plane. Where, as illustrated in FIGS. 13-14, the input center ray 1006 is disposed at a complex angle relative to the grating vector k0 of the in-coupling diffractive optic 1002, the vector diagram formed by the grating vectors k0, k1, k2/k3 defines a scalene triangle.

In an embodiment, the layout pattern of the diffractive optical elements may be directly formed or written onto and/or into a surface of a mold substrate using, but not limited to, the methods of electron beam (e-beam) lithography, ion beam lithography, laser lithography, and/or other digital beam writing. In digital beam writing production of a mold substrate, straight line diffractive features that are not parallel to the beam writing machines' x- and/or y-axis are produced in a zigzag or step pattern. As previously described with regard to FIG. 7, the unit cell 310 includes a vertical offset 350 and the unit cell 410A, 410B includes a vertical offset 450. The vertical offset 350, 450 is the step change from one unit cell 310, 410A, 410B to a neighboring unit cell 310, 410A, 410B.

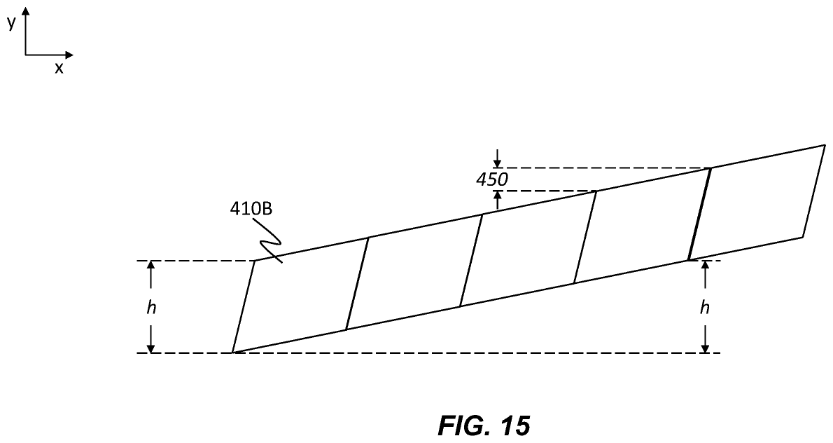

For digital beam writing, the vertical offset 350, 450 needs to divide evenly into a multiple of the height h of the unit cell 310, 410A, 410B by a discrete value to ensure the non-regular hexagonal unit cell 310, 410A, 410B repeats to form the compound diffractive optical pattern. FIG. 15 shows a simplified schematic of a portion of the pupil expansion compound diffraction grating 706 comprising repeating unit cells 410B. In FIG. 15, the unit cells 410B are parallelograms and illustrate the principle that the vertical offset 350, 450 is selected to divide evenly into a multiple of the height of the unit cell 310, 410A, 410B by a discrete value to create the compound diffractive optical pattern 706 utilizing repeating unit cells 310, 410A, 410B. For example, as illustrated in FIG. 15, the unit cell height h may be four-times (4×) the vertical offset 450. A unit cell is the smallest area within the compound diffractive pattern that repeats. When the unit cell 410B describes a parallelogram with a vertical offset, the compound diffractive pattern forms grating vectors describing a scalene triangle.

Digitally writing the unit cells 310, 410A, 410B allows for better reproducibility than conventional methods for creating diffractive elements. Additionally, digital beam writing facilitates optimization of diffraction orders. The diffraction orders can be optimized by changing diffractive feature duty cycle, shape, and depth which can be symmetrically produced via digital writing.

For example, orienting a mold substrate such that the diffractive features 320, 328, 322 are substantially parallel with a preferred write direction of the beam writing machine (parallel to the beam writing machines' x- or y-axis) orients the angle of the diffractive features 312, 324, 314 and the angle of the diffractive features 316, 326, 318 such that any error in the write process is respectively mirrored in each unit cell 310. In other words, a grating vector of the unit cell 310, 410A, 410B is aligned parallel with a preferred write direction of the beam writing machine (parallel to the beam writing machines' x- or y-axis).

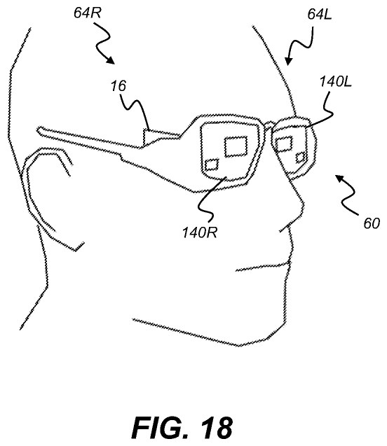

The perspective view of FIG. 18 shows a display system 60 for three-dimensional (3-D) augmented reality viewing using a pair of image light guides of the present disclosure. Display system 60 is shown as a HMD with a left-eye optical system 64L having an image light guide 140L for the left eye and a corresponding right-eye optical system 64R having an image light guide 140R for the right eye. An image source 16, such as a picoprojector or similar device, can be provided, energizable to generate a separate image for each eye, formed as a virtual image with the needed image orientation for upright image display. The images that are generated can be a stereoscopic pair of images for 3-D viewing. The virtual image that is formed by the optical system can appear to be superimposed or overlaid onto the real-world scene content seen by the viewer through an image light guide. Additional components familiar to those skilled in the augmented reality visualization arts, such as one or more cameras mounted on the frame of the HMD for viewing scene content or viewer gaze tracking, can also be provided. Alternate arrangements are possible, including a display apparatus for providing an image to one eye (e.g., a monocular display).

One or more features of the embodiments described herein may be combined to create additional embodiments which are not depicted. While various embodiments have been described in detail above, it should be understood that they have been presented by way of example, and not limitation. It will be apparent to persons skilled in the relevant arts that the disclosed subject matter may be embodied in other specific forms, variations, and modifications without departing from the scope, spirit, or essential characteristics thereof. The embodiments described above are therefore to be considered in all respects as illustrative, and not restrictive. The scope of the invention is indicated by the appended claims, and all changes that come within the meaning and range of equivalents thereof are intended to be embraced therein.

what is claimed is:

1. An image light guide for conveying image bearing light, comprising:
a substrate operable to propagate image-bearing light beams along a length thereof;
an in-coupling diffractive optic formed along said substrate, wherein said in-coupling diffractive optic is operable to diffract a portion of said image-bearing light beams from an image source into said substrate in an angularly encoded form;
an out-coupling diffractive optic formed along said substrate, wherein said out-coupling diffractive optic is at least partially located in a plane having an x-axis and a y-axis, and is operable to diffract a portion of said image-bearing light beams from said substrate in an angularly decoded form;
wherein said out-coupling diffractive optic comprises a first plurality of periodic structures and a second plurality of periodic structures, said first and second pluralities of periodic structures operable to diffract a portion of said image-bearing light beams into diffractive orders, and
wherein said first and second pluralities of periodic structures comprise a plurality of vertices, wherein each adjacent vertex along said x-axis is offset in said y-axis direction.

2. The image light guide for conveying image bearing light according to claim 1, wherein:
said in-coupling diffractive optic defines a first grating vector; and
said out-coupling diffractive optic defines a second grating vector and a third grating vector.

3. The image light guide for conveying image bearing light according to claim 2, wherein said second grating vector is arranged at a first angle relative to said first grating vector, and said third grating vector is arranged at a second angle relative to said first grating vector.

4. The image light guide for conveying image bearing light according to claim 2, wherein said first, second, and third grating vectors create a scalene triangle.

5. The image light guide for conveying image bearing light according to claim 1, wherein a center ray of said image-bearing light beams from said image source is disposed at a first angle relative to said x-y plane and a second angle within said x-y plane relative to said in-coupling diffractive optic.

6. The image light guide for conveying image bearing light according to claim 1, wherein:
said out-coupling diffractive optic is operable to diffract a portion of a first portion of each of said image-bearing light beams in a first direction via incidence with said first plurality of periodic structures, whereby said first portion of each of said image-bearing light beams is expanded in a first dimension, and
said out-coupling diffractive optic is operable to diffract a portion of a second portion of each of said image-bearing light beams in a second direction via incidence with one or more of said second plurality of periodic structures, whereby said second portion of each of said image-bearing light beams is expanded in a second dimension.

7. The image light guide for conveying image bearing light according to claim 6, wherein:
said out-coupling diffractive optic is operable to diffract a portion of said first portion of each of said image-bearing light beams expanded in said first dimension out of said substrate via incidence with said second plurality of periodic structures, and
said out-coupling diffractive optic is operable to diffract a portion of said second portion of each of said image-bearing light beams expanded in said second dimension out of said substrate via incidence with said first plurality of periodic structures.

8. The image light guide for conveying image bearing light according to claim 1, wherein said first and second pluralities of periodic structures comprise overlapped parallel straight line diffractive features.

9. The image light guide for conveying image bearing light according to claim 8, wherein said in-coupling diffractive optic comprises a plurality of parallel straight line diffractive features,
said first plurality of periodic structures are oriented at a first angle relative to said plurality of parallel straight line diffractive features of said in-coupling diffractive optic, and
said second plurality of periodic structures are oriented at a second angle relative to said plurality of parallel straight line diffractive features of said in-coupling diffractive optic,
wherein said first angle is greater than said second angle.

10. The image light guide for conveying image bearing light according to claim 1, wherein said in-coupling diffractive optic and said out-coupling diffractive optic are formed in a first surface of said substrate.

11. The image light guide for conveying image bearing light according to claim 1, wherein said out-coupling diffractive optic comprises a plurality of unit cells, each said unit cell defining an irregular hexagon.

12. The image light guide for conveying image bearing light according to claim 11, wherein a height of each unit cell is a multiple of said offset of said vertices.

13. The image light guide for conveying image bearing light according to claim 1, wherein said first and second pluralities of periodic structures comprise portions of line structures.

14. The image light guide for conveying image bearing light according to claim 1, wherein said out-coupling diffractive optic is formed of a volume holographic material.

15. The image light guide for conveying image bearing light according to claim 1, wherein said first and second pluralities of periodic structures define triangular area domains.

16. The image light guide for conveying image bearing light according to claim 15, wherein said area domains comprise scalene triangles, whereby said image-bearing light beams incoming from an image source at a non-normal angle to said in-coupling diffractive optic are diffracted.

17. A method of fabricating an image light guide for conveying image bearing light, comprising:
providing a substrate having a first surface, wherein a coating is coupled with said first surface;
providing a beam writing system operable to write in a first direction and a second direction, wherein said second direction is perpendicular to said first direction;
providing a diffraction grating layout pattern comprising a plurality of unit cells, each said unit cell comprising:
a first plurality of straight line diffractive features, and
a second plurality of straight line diffractive features,
wherein one or more intersections of said first and second pluralities of straight line diffractive features define one or more corresponding vertices,
wherein adjacent vertices along said first direction comprise an offset along said second direction;
locating said substrate in said beam writing system, whereby said beam writing system is operable to write into said coating;
aligning one of said first and second pluralities of straight line diffractive features parallel with said beam writing system first direction; and
writing said diffraction grating layout pattern into said coating via said beam writing system.

18. The method of fabricating an image light guide for conveying image bearing light according to claim 17, wherein a height of each unit cell is a multiple of said offset of said vertices.

19. An image light guide for conveying image bearing light, comprising:
a substrate operable to propagate image-bearing light beams along a length thereof;
an in-coupling diffractive optic formed along said substrate, wherein said in-coupling diffractive optic is operable to diffract a portion of said image-bearing light beams from an image source into said substrate in an angularly encoded form;
an out-coupling diffractive optic formed along said substrate, wherein said out-coupling diffractive optic is at least partially located in a plane having an x-axis and a y-axis, and is operable to diffract a portion of said image-bearing light beams from said substrate in an angularly decoded form;
wherein said out-coupling diffractive optic comprises a plurality of contiguous periodic structures defining sinusoidal rows operable to diffract a portion of said image-bearing light beams into diffractive orders, and
wherein said plurality of contiguous periodic structures comprise a plurality of vertices, wherein each adjacent vertex along said x-axis is offset in said y-axis direction.

20. The image light guide for conveying image bearing light according to claim 19, wherein a first sinusoidal row is out of phase with a second sinusoidal row of said out-coupling diffractive optic.
